(19) United States
(12) Patent Application Publication
(10) Pub. No.: US 2010/0189014 A1
(43) Pub. Date: Jul. 29, 2010

(54) SYSTEM AND METHOD OF DISTRIBUTING NODE CONFIGURATION INFORMATION

(76) Inventors: Dirk Hogan, Corvallis, OR (US); Ted Beers, Corvallis, OR (US); Evan Scheessele, Corvallis, OR (US); Keith M. Taylor, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/598,185

(22) PCT Filed: Apr. 30, 2007
(86) PCT No.: PCT/US07/67827

§ 371 Date: Apr. 14, 2010

(51) Int. Cl. H04L 12/28

(52) U.S. Cl. 370/255

(57) ABSTRACT

A system of distributing node configuration information to a plurality of nodes in an event is provided. The system includes a first node, a second node operatively connected to the first node, and an event manager operatively connected to the first node and the second node. The event manager transmits the node configuration information to the first node and the second node, and transmits an indication to the first node and the second node to initiate communication between the first node and the second node using the node configuration information.

### CROSS-REFERENCE TO RELATED APPLICATIONS

This application is related to copending patent application Ser. No. 11/497886 entitled “System and Method for Managing Virtual Collaboration Systems,” filed on Aug. 2, 2006 and assigned to the same assignee as the present application, the disclosure of which is incorporated herein by reference.

### BACKGROUND

Multimedia content is commonly transmitted between users over networks, such as local area networks (LANs) and the Internet. Examples of multimedia content include text, audio content, visual content, and any combination thereof. Security measures are sometimes necessary to ensure that an eavesdropper cannot access confidential multimedia content transmitted over the network.

As a way to ensure security, a sender may encrypt multimedia content prior to sending the encrypted multimedia content, and a receiver can decrypt the encrypted multimedia content after receiving the encrypted multimedia content. Common types of encryption systems include asymmetric encryption and symmetric encryption. Asymmetric encryption is implemented using public key encryption, in which a message encrypted with a subject's public key can be decrypted only by a receiver possessing the subject's corresponding private key. However, asymmetric encryption is generally too slow for real-time applications, such as streaming applications or virtual meetings, where the encryption and decryption operations need to be executed with little or no noticeable latency.

Symmetric encryption is implemented using a single secret key shared between users for encryption and decryption. Symmetric encryption is generally faster than asymmetric encryption which makes symmetric encryption better suited for real-time applications and other applications where minimal latency is desired. However, difficulty may arise with securely distributing and redistributing the secret key to the users.

Because secret keys are used for both encryption and decryption, secret keys are generally distributed prior to initiating communications between two or more users. Secret keys may also need to be regenerated and redistributed for a number of reasons. In one example, a hardware failure at one or more nodes (e.g., resulting in failover to a redundant system) may require redistributing the secret key. In another example, when a user is removed from an event, the secret key may need to be regenerated and redistributed to the remaining users in order to prevent the departed user from further access. Secure distribution and redistribution of secret keys can be difficult when the users are geographically dispersed. Further, for certain applications, the secure distribution and redistribution of secret keys may need to be seamless, causing minimal interruption to the communications and requiring minimal intervention from the end users. For these and other reasons, there is a need for the present invention.

### SUMMARY

One embodiment provides a system of distributing node configuration information to a plurality of nodes in an event. The system includes a first node, a second node operatively connected to the first node, and an event manager operatively connected to the first node and the second node. The event manager transmits the node configuration information to the first node and the second node, and transmits an indication to the first node and the second node to initiate communication between the first node and the second node using the node configuration information.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a block diagram of a node-based, key management system.

FIG. 2 illustrates a block diagram of a pull-based, symmetric key distribution system utilizing a central server.

FIGS. 3A and 3B illustrate block diagrams of a push-based, symmetric key distribution system utilizing an event manager, in accordance with one embodiment.

FIG. 4 illustrates a diagram of an exemplary sequence of operations in which an event manager distributes a symmetric key to a first node and a second node, in accordance with one embodiment.

FIG. 5 illustrates a flow diagram of a method of distributing a symmetric key to a first node and a second node, in accordance with one embodiment.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

As used herein, the term “media” includes text, audio, video, sounds, images, or other suitable digital data capable of being transmitted over a network.

As used herein, the term “node device” includes processor-based devices, input/output devices, or other suitable devices for facilitating communications among remote users. Examples of node devices include fax machines, video cameras, telephones, printers, scanners, displays, personal computers, microphones, and speakers.

As used herein, the term “node” includes any suitable environment or system configured to transmit and/or receive media via one or more node devices. In one embodiment, the environment is a collaborative environment, which enables remote users to share media across one or more node devices. A collaborative environment will enable, for example, a presenter to simultaneously give a multimedia presentation to an audience not only in the presenter's location but also in one or more remote locations. The collaborative environment may further enable the audience in the remote locations to participate in the presentation as the audience in the presenter's location would participate (e.g., ask questions to the presenter).

As used herein, the term “event” refers to a connection of a plurality of nodes such that one or more node devices of one node are configured to transmit media to and/or receive media from one or more node devices of another node.

As used herein, the term “topology” refers to an event and its respective configuration, state, and relationship to other systems associated with the event. An exemplary event topology may include an event manager, a plurality of nodes, and one or more relationships among the event manager and the plurality of nodes. For the sake of simplicity, event topology described herein generally includes only two nodes. It should be appreciated that an event may include any suitable number of nodes as contemplated by those skilled in the art.

As used here, the term “node configuration information” refers to any suitable information utilized to configure a node prior to the node transmitting and receiving media. In one embodiment, the node configuration information is a symmetric key distributed to a node to encrypt media prior to transmission and decrypt media upon reception. In another embodiment, the node configuration information is topology information. In one example, the topology information may be one or more network addresses distributed to a node establishing one or more communication streams to transmit media. In another example, the topology information may indicate that the environment at a node during the event needs to be adjusted (e.g., dimming the lighting within the node) in accordance with a policy of the node.

Embodiments of a system and method of distributing node configuration information are described herein. Embodiments include an atomic, two-step process for distributing node configuration information. As an atomic process, multiple operations are executed as though operating as one operation. For the sake of simplicity, embodiments described herein refer to the distribution of a symmetric key. It should be appreciated, however, that one of ordinary skill in the art will recognize that other node configuration information can be distributed in view of the embodiments described herein.

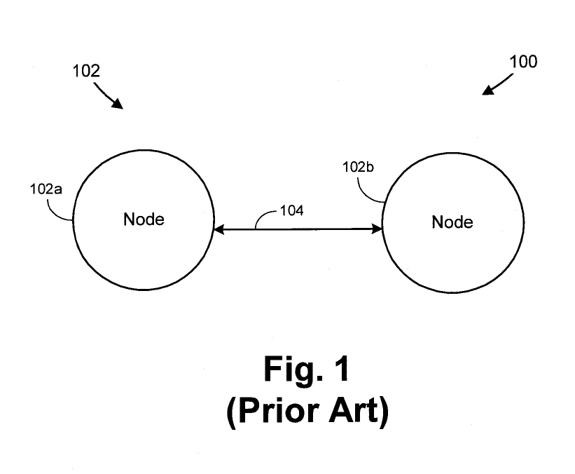

FIG. 1 illustrates a block diagram of a node-based, key management system 100 including a first node 102a operatively connected to a second node 102b (collectively referred to as nodes 102). Under node-based system 100, first node 102a and second node 102b each maintain and negotiate a symmetric key via network 104. Secure communications (e.g., sharing media) between nodes 102 is initiated only after nodes 102 have negotiated a symmetric key. An example of a node-based system is IP Security (i.e., IPsec or RFC 2401).

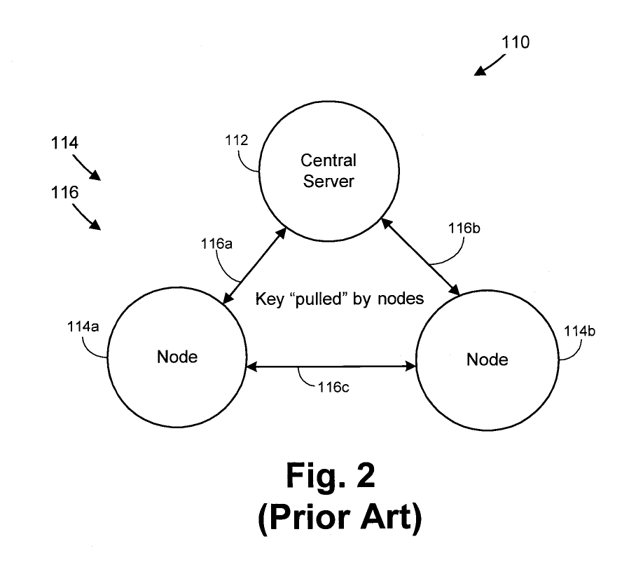

FIG. 2 illustrates a block diagram of a pull-based, symmetric key distribution system 110 utilizing a central server 112. Central server 112 is operatively connected to a first node 114a and a second node 114b (collectively referred to as nodes 114). First node 114a and second node 114b are also operatively connected.

Under pull-based system 110, first node 114a and second node 114b actively obtain a symmetric key from central server 112 via networks 116a and 116b, respectively. In other words, central server 112 does not send the symmetric key to first node 114a or second node 114b until requested by first node 114a and second node 114b, respectively. First node 114a and second node 114b communicate (e.g., share media) with each other via network 116c after obtaining the symmetric key from central server 112. An example of a pull-based system is the Multicast Group Security Architecture (i.e., RFC 3740).

Node-based system 100 and pull-based system 110 require nodes 102 and 104 to each manage their individual need to negotiate or acquire the symmetric key, which may result in a number of potential problems. In one example, a node may not be aware of certain hardware failures, whether from the node itself or from another node, that require the regeneration and/or redistribution of keys. The failing node would effectively become inoperative since it may not know to request a new key.

In another example, if a policy controlling when to request a new key changes (e.g., whether to change the key when a node departs from an event), the policy would have to be changed for every node involved. Depending on the number of nodes, changing the policy for every node may be unduly time-consuming. In addition, requiring each node to manage policies may be computationally intensive. Furthermore, a number of security protocols, such as IPsec and Secure Real-Time Transport Protocol (SRTP), provide little or no flexibility with policies, specifying, for example, that symmetric keys be regenerated only after a specific number of network packets have been sent.

Embodiments of a system and method of distributing a symmetric key to a plurality of nodes will now be described. In one embodiment, the system and method utilize a push-based, symmetric key distribution system in which a central, key manager, as one embodiment of an event manager, distributes the symmetric key to nodes without request from the nodes. The push-based system enables the key manager to globally monitor failures and other occurrences of each and every node that require the regeneration and redistribution of the keys. Further, the push-based system enables the implementation of flexible policies governing the keys by providing a central point at which to implement policies.

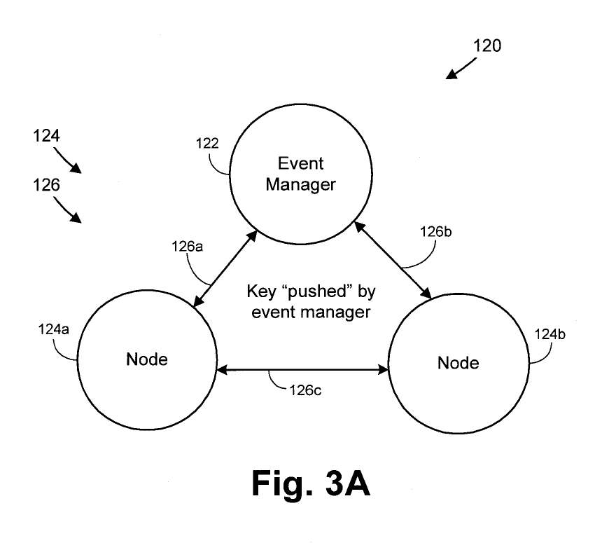

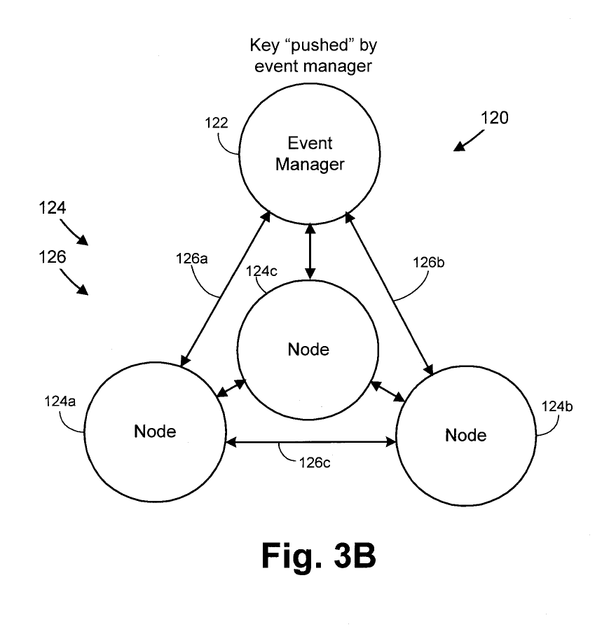

FIG. 3A illustrates a block diagram of a push-based, symmetric key distribution system 120 utilizing an event manager 122, in accordance with one embodiment. Event manager 122 is operatively connected to a first node 124a and a second node 124b (collectively referred to as nodes 124). First node 124a and second node 124b are also operatively connected.

Under push-based system 120, event manager 122 manages the distribution of keys to nodes 124 via networks 126a and 126b. Nodes 124 are not required to request the symmetric keys and, in one embodiment, nodes 124 are preferably not involved with key distribution. Thus, push-based system 120 frees the nodes of administrative responsibilities regarding the key distribution. Event manager 122 is responsible for monitoring the overall event topology and for managing the key distribution accordingly. Further, push-based system 120 enables the use of flexible policies regarding the generation, regeneration, distribution, and redistribution of symmetric keys.

Push-based system 120 enforces an atomic, two-step process related to key distribution. In the first step, a symmetric key is distributed to each of first node 124a and second node 124b. In the second step, communications (e.g., sharing media) between first node 124a and second node 124b via network 126c are initialized. The atomicity of the two-step process means that both steps are effectively viewed and regarded as a single operation although two separate steps are involved. In one embodiment, the two-step process is modeled based on a two-phase commit protocol, as applied to transactive distributed systems.

In one embodiment, event manager 122 receives from first node 124a and second node 124b data related to the participation by first node 124a and second node 124b, respectively, in an event. In response to receiving the data from first node 124a and second node 124b, event manager 122 generates and distributes the proper symmetric key based on a policy. Examples of data sent from nodes 124 to event manager 122 may include notification to participate in an event and the manner in which nodes 124 desire to participate in the event. In one embodiment, event manager 122 sends additional information related to executing the event between nodes 124. Such information may include any suitable communication information, such as the network protocol (e.g., real-time transfer protocol), network addresses of node devices, and ports.

In one embodiment, as illustrated in FIG. 3B, first node 124a and second node 124b each send notification to event manager 122 to send and receive media to and from a third node 124c. Event manager 122 determines the symmetric keys to be sent to first node 124a, second node 124b, and third node 124c based on a policy. The policy may indicate, for example, that communications between first node 124a and third node 124c utilize a different symmetric key than between second node 124b and third node 124c. Under this policy, a first symmetric key is sent to first node 124a and third node 124c along with information indicating that the first symmetric key is for communications between first node 124a and third node 124c. A second symmetric key, which is different from the first symmetric key, is sent to second node 124b and third node 124c along with information indicating that the second symmetric key is for communications between second node 124b and third node 124c. First node 124a, second node 124b, and third node 124c are unconcerned with the policy, which is maintained by event manager 122.

In another embodiment, the policy specifies that a first symmetric key is used for a first communication stream between first node 124a and second node 124b, and a second symmetric key is used for a second communication stream between first node 124a and second node 124b. In another embodiment, the policy specifies that a first symmetric key is used for communication from first node 124a to second node 124b, and a second symmetric key is used for communication from second node 124b to first node 124a. In another embodiment, the policy specifies generating a new symmetric key and transmitting the new symmetric key to one or more of nodes 124 in response to a given amount of time passing. In another embodiment, the policy specifies generating a new symmetric key and transmitting the new symmetric key to one or more of nodes 124 in response to updated node information from one or more of nodes 124. An example of updated node information is information regarding a hardware failure at one or more of nodes 124.

In another embodiment, the policy specifies generating a new symmetric key and transmitting the new symmetric key to one or more of nodes 124 in response to a new node joining the event. In another embodiment, the policy specifies generating a new symmetric key and transmitting the new symmetric key to one or more of nodes 124 in response to an existing node leaving the event. Thus, the symmetric key is regenerated and redistributed in response to a new node joining the event or an existing node leaving the event. A request to join the event and/or leave the event may be received from or originate from one or more of nodes 124, as well as, from a scheduler application (e.g., when a scheduled trigger to “up the security” comes in) or a support application used by a Concierge (e.g., when a person calls to request a security refresh). In other embodiments, the policy specifies any suitable rules for generating, regenerating, distributing, and redistributing symmetric keys.

In accordance with the atomic, two-step process previously described, after event manager 122 sends the appropriate symmetric keys to nodes 124 based on the policy and the node information, event manager 122 instructs each of nodes 124 to begin communications using the symmetric keys. Thus, the symmetric keys enable nodes 124 to securely communicate with each other.

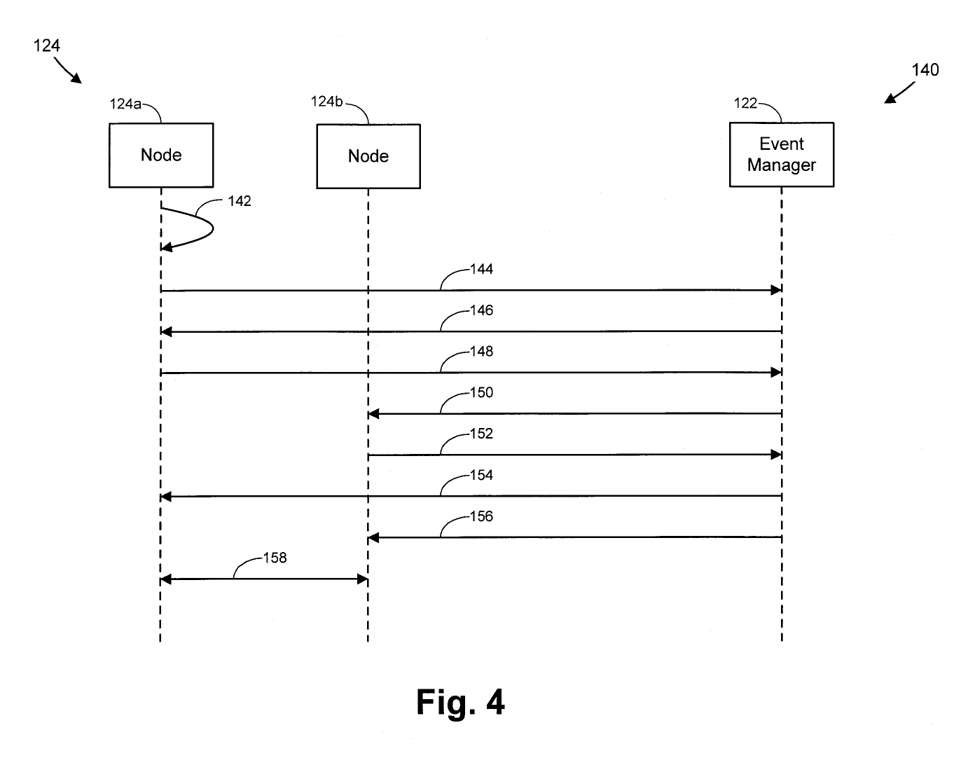

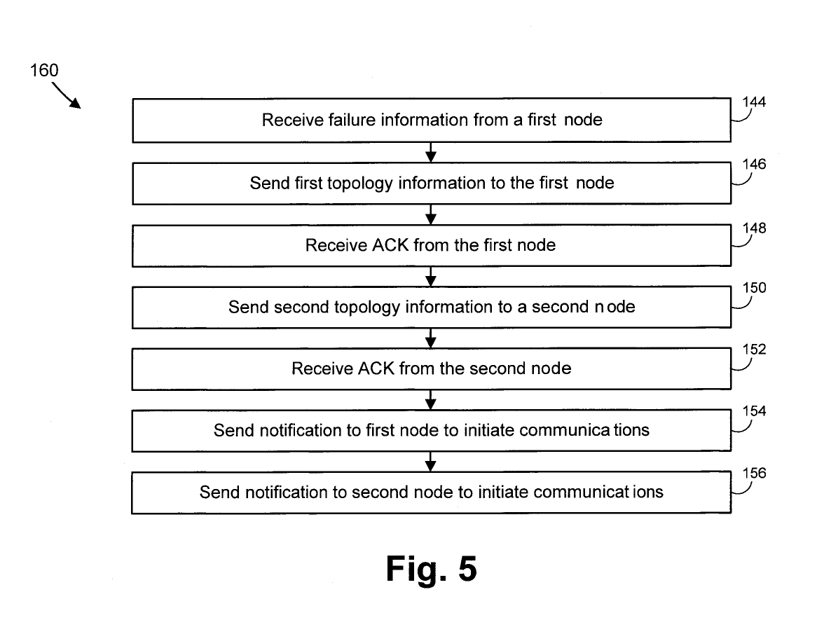

FIG. 4 illustrates a diagram of an exemplary sequence 140 of operations in which event manager 122 distributes a symmetric key to a first node 124a and a second node 124b, in accordance with one embodiment. FIG. 5 illustrates a flow diagram of a method 160 of distributing a symmetric key to a first node 124a and a second node 124b, in accordance with one embodiment. Reference will now be made to FIGS. 4 and 5.

In one embodiment, first node 124a experiences a failure (at 142) in a communications pipeline with second node 124b. In one embodiment, when a communications pipeline fails in first node 124a, first node 124a executes a failover to a redundant system. In one embodiment, a policy enforced by event manager 122 requires that event manager 122 regenerate and redistribute a symmetric key to first node 124a and second node 124b when first node 124a executes failover to a redundant system.

In one embodiment, event manager 122 receives (at 144) failure information from first node 124a. Failure information includes a notification that first node 124a experienced a failure. Failure information may further include any suitable information related to first node 124a, such as the current capabilities of first node 124a (i.e., the capabilities of first node 124a after the failure) to participate in an event.

In one embodiment, event manager 122 sends (at 146) first topology information to first node 124a. The first topology information includes a symmetric key for communications with second node 124b. In one embodiment, the symmetric key is determined based on the failure information. The first topology information may further include any suitable communication information related to communications between first node 124a and second node 124b, such as the network protocol, network addresses of node devices, and ports.

In one embodiment, event manager 122 receives (at 148) from first node 124a an acknowledgement (ACK) indicating that first node 124a received the first topology information.

In one embodiment, event manager 122 sends (at 150) second topology information to second node 124b. The second topology information may or may not be the same as the first topology information. The second topology information includes the symmetric key also sent to first node 124 through the first topology information. The second topology information may further include any suitable communication information related to communications between first node 124a and second node 124b, such as the network protocol, network addresses of node devices, and ports.

In one embodiment, event manager 122 receives (at 152) from second node 124b an acknowledgement (ACK) indicating that second node 124b received the second topology information.

In one embodiment, event manager 122 sends (at 154) notification to first node 124a to initiate communications with second node 124b. Event manager 122 also sends (at 156) notification to second node 124b to initiate communications with first node 124a. Thereafter, an event begins, and media is securely transferred (at 158) between first node 124a and second node 124b using the symmetric key to encrypt and decrypt communications. In one embodiment, media is not transferred between first node 124a and second node 124b until the atomic, two-step process of distributing the symmetric key (i.e., steps 146 to 152) and initiating the communications (i.e., steps 154 and 156) is completed.

To ensure the atomic, two-step process as previously described, one or more policies may be implemented to account for a failure in any of the steps 146 to 156. In one embodiment, failure of any of the steps 146 to 156 results in a “rollback” sequence in which any steps prior to the failed step are undone to a previous or initial state. In one embodiment, the steps 146 to 156 are re-executed until the symmetric key is successfully distributed. In another embodiment, the event or the intended communication between nodes 124 is terminated. In another embodiment, the intended communication between nodes 124 continues unencrypted.

In one embodiment, the failure information is included in a prioritized intent, as disclosed in above-referenced patent application Ser. No. 11/497886 entitled “System and Method for Managing Virtual Collaboration Systems.” In one embodiment the first topology information and the second topology information are included in a selected intent, as disclosed in above-referenced patent application Ser. No. 11/497886 entitled “System and Method for Managing Virtual Collaboration Systems.” In one embodiment, the functionality of event manager 122 is divided into an event manager and an event focus, as disclosed in above-referenced patent application Ser. No. 11/497886 entitled “System and Method for Managing Virtual Collaboration Systems.

Embodiments described and illustrated with reference to the Figures provide systems and methods of distributing node configuration information. It is to be understood that not all components and/or steps described and illustrated with reference to the Figures are required for all embodiments. In one embodiment, one or more of the illustrative methods are preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system of distributing node configuration information to a plurality of nodes in an event, comprising:
a first node;
a second node operatively connected to the first node; and
an event manager operatively connected to the first node and the second node, wherein the event manager transmits the node configuration information to the first node and the second node, and transmits an indication to the first node and the second node to initiate communication between the first node and the second node using the node configuration information.

2. The system of claim 1, wherein the communication between the first node and the second node is initiated only after the event manager successfully transmits the node configuration information and the indication to the first node and the second node.

3. The system of claim 1, wherein the event manager generates the node configuration information.

4. The system of claim 1, wherein the node configuration information includes a symmetric key.

5. The system of claim 4, wherein the communication between the first node and the second node is initiated only after the event manager successfully transmits both the symmetric key and the indication to the first node and the second node.

6. The system of claim 4, wherein the event manager generates the symmetric key and transmits the symmetric key to the first node and the second node in accordance with a policy.

7. The system of claim 6, wherein the policy specifies that a first symmetric key is used for the communication between the first node and the second node, and a second symmetric key is used for communication between the second node and a third node.

8. The system of claim 6, wherein the policy specifies that a first symmetric key is used for a first communication stream between the first node and the second node, and a second symmetric key is used for a second communication stream between the first node and the second node.

9. The system of claim 6, wherein the policy specifies that a first symmetric key is used for communication from the first node to the second node, and a second symmetric key is used for communication from the second node to the first node.

10. The system of claim 6, wherein the policy specifies that a new symmetric key is generated and transmitted to the first node and the second node in response to at least one of a given amount of time passing and receiving updated node information from one of the first node and the second node.

11. The system of claim 10, wherein the updated node information is information regarding a hardware failure.

12. The system of claim 1, further comprising:
a third node,
wherein the event manager generates a new symmetric key and transmits the new symmetric key to at least two of the first node, the second node, and the third node in response to receiving at least one of a request to join the event and a request to leave the event.

13. The system of claim 1, wherein the node configuration information includes topology information.

14. The system of claim 13, wherein the topology information comprises at least one of a network protocol, a network address of a node device, and a port associated with the communication between the first node and the second node.

15. The system of claim 1, wherein the first node and the second node are geographically-dispersed.

16. The system of claim 1, wherein the communication between the first node and the second node comprises sharing media.

17. The system of claim 1, wherein the event manager generates the node configuration information without request from one of the first node and the second node, transmits the node configuration information to the first node and the second node without request from one of the first node and the second node, and transmits the indication to the first node and the second node without request from one of the first node and the second node.

18. A method of distributing node configuration information to a plurality of nodes in an event, comprising:
transmitting the node configuration information to a first node;
receiving acknowledgment from the first node that the first node received the node configuration information;
transmitting the node configuration information to a second node;
receiving acknowledgement from the second node that the second node received the node configuration information; and
transmitting an indication to the first node and the second node to initiate communication between the first node and the second node using the node configuration information.

19. The method of claim 18, further comprising:
transmitting the node configuration information to the first node and the second node in response to receiving failure information from the first node.

20. The method of claim 19, wherein the failure information comprises notification that at least a portion of the first node has failed, and a current capability of the first node.

21. The method of claim 18, further comprising:
transmitting the node configuration information to the first node and the second node in response to receiving at least one of a request to join the event and a request to leave the event.

22. The method of claim 18, wherein the node configuration information includes topology information.

23. The method of claim 22, wherein the topology information comprises at least one of a network protocol, a network address of a node device, and a port associated with the communication between the first node and the second node.

24. The method of claim 18, wherein the node configuration information includes a symmetric key.

25. The method of claim 24, further comprising:
initiating the communication between the first node and the second node only after successfully transmitting both the symmetric key and the indication to the first node and the second node.

26. The method of claim 24, further comprising:
generating the symmetric key based on a policy.

27. The method of claim 26, wherein the policy specifies using a first symmetric key for the communication between the first node and the second node, and using a second symmetric key for communication between the second node and a third node.

28. The method of claim 26, wherein the policy specifies using a first symmetric key for a first communication stream between the first node and the second node, and using a second symmetric key for a second communication stream between the first node and the second node.

29. The method of claim 26, wherein the policy specifies using a first symmetric key for communication from the first node to the second node, and using a second symmetric key for communication from the second node to the first node.

30. The method of claim 26, wherein the policy specifies generating a new symmetric key and transmitting the new symmetric key to the first node and the second node in response to at least one of a given amount of time passing and receiving updated node information from one of the first node and the second node.

31. The method of claim 30, wherein the updated node information is information regarding a hardware failure.

32. The method of claim 26, wherein the policy specifies generating a new symmetric key and transmitting the new symmetric key to at least two of the first node, the second node, and a third node in response to receiving at least one of a request to join the event and a request to leave the event.

33. The method of claim 18, wherein the communication between the first node and the second node comprises sharing media.

34. The method of claim 18, wherein the first node and the second node are geographically-dispersed.

35. The method of claim 18, further comprising:
generating the node configuration information without request from one of the first node and the second node; and
transmitting the node configuration information without request from one of the first node and the second node.

36. A machine-readable medium having instructions stored thereon for execution by a processor to perform a method of distributing node configuration information to a plurality of nodes in an event, the method comprising:
transmitting the node configuration information to a first node in the event;
receiving acknowledgment from the first node that the first node received the node configuration information;
transmitting the node configuration information to a second node in the event;
receiving acknowledgement from the second node that the second node received the node configuration information; and
transmitting an indication to the first node and the second node to initiate communication between the first node and the second node using the node configuration information,
wherein the communication between the first node and the second node is initiated only after successfully transmitting both the node configuration information and the indication to the first node and the second node.

37. The machine-readable medium of claim 36, wherein the node configuration information comprises at least one of a network protocol, a network address of a node device, and a port associated with the communication between the first node and the second node.

38. The machine-readable medium of claim 36, wherein the node configuration information comprises a symmetric key.

39. The machine-readable medium of claim 38, further comprising:
generating the symmetric key and transmitting the symmetric key to at least two of the first node, the second node, and a third node in response to receiving at least one of a request to join the event and a request to leave the event.
